(19) United States
(12) Patent Application Publication
(10) Pub. No.: US 2020/0391978 A1
(43) Pub. Date: Dec. 17, 2020

(54) ELEVATOR

(71) Applicant: LIFTEC CORPORATION, Jincheon-gun, Chungcheongbuk-do (KR)

(72) Inventors: Kyung Nam YOU, Yongin-si, Gyeonggi-do (KR); Jun JUNG, Jincheon-gun, Chungcheongbuk-do (KR); Hong Ku JEONG, Gwangju-si, Gyeonggi-do (KR); Seung Woo KIM, Jincheon-gun, Chungcheongbuk-do (KR); Tae Yun KIM, Bupyeong-gu, Incheon (KR); Cheng Ji LIAN, Eumseong-gun, Chungcheongbuk-do (KR); Kwang Hyun LEE, Jincheon-gun, Chungcheongbuk-do (KR)

(21) Appl. No.: 16/763,138

(22) PCT Filed: Nov. 21, 2017
(86) PCT No.: PCT/KR2017/013228

§ 371 Date: May 11, 2020

(51) Int. Cl. B66B 7/02

(52) U.S. Cl. CPC B66B 7/025; B66B 9/187

(57) ABSTRACT

An elevator of the present invention includes a guide member spaced apart from a structure and formed in a vertical direction with respect to the ground, a first elevating member coupled to the guide member to be moveable in a longitudinal direction of the guide member, a second elevating member coupled to the guide member to be moveable in the longitudinal direction of the guide member, detachably coupled to a lower side of the first elevating member, and lifted and lowered together with the first elevating member, and at least one connecting unit which connects the first elevating member and the second elevating member.

### TECHNICAL FIELD

The present invention relates to an elevator, and more specifically to, an elevator usable to transfer a worker or a construction material.

### BACKGROUND ART

In construction sites, elevators are installed on outer walls of structures of which frame construction is being built or completed to move workers or rapidly supply construction materials, such as cement and steel beams, and the like. Due to such an installation of the elevator, the construction may be conveniently and rapidly performed so that construction periods may be reduced.

However, in the conventional general construction elevator, one carrier is installed on a vertical frame to be liftable and lowerable and is driven. Accordingly, when the elevator is installed on a high structure and a carrier is driven, a time required for operating the carrier is too long, and thus there are problems in that transfer efficiency of the carrier and work efficiency are reduced.

### DISCLOSURE

### Technical Problem

The present invention is directed to providing an elevator allowing transfer efficiency of a worker and a construction material to be improved.

### Technical Solution

One aspect of the present invention provides an elevator including a guide member spaced apart from a structure and formed in a vertical direction with respect to the ground, a first elevating member coupled to the guide member to be moveable in a longitudinal direction of the guide member, a second elevating member coupled to the guide member to be moveable in the longitudinal direction of the guide member, detachably coupled to a lower side of the first elevating member, and lifted and lowered together with the first elevating member, and at least one connecting unit which connects the first elevating member and the second elevating member.

The connecting unit may include a first extension member formed to extend from the lower side of the first elevating member toward the second elevating member, a second extension member formed to extend from an upper side of the second elevating member toward the second elevating member and corresponding to the first extension member, a fixing member formed to protrude in a direction away from a side surface of any one of the first extension member or the second extension member, and a hook member rotatably coupled to a side surface of any one of the first extension member or the second extension member and coupled to the fixing member.

The elevator may include a spacing unit formed between the first elevating member and the second elevating member so that the first elevating member and the second elevating member are spaced apart from each other by a predetermined distance.

The spacing unit may include a support member having a height and formed on any one of the lower side of the first elevating member and an upper side of the second elevating member, and an elastic member which is formed on the remaining one of the lower side of the first elevating member and the upper side of the second elevating member to be elastically deformed and elastically supports the support member The elevator may include at least one driving unit which is installed at one side of the first elevating member and generates power to lift and lower the first elevating member and the second elevating member along the guide member.

### Advantageous Effects

In an elevator according one embodiment of the present invention, when there are many construction materials to be transferred, since a first elevating member and a second elevating member are simultaneously moved, an amount of materials transferred at once can be increased approximately twice when compared to a conventional elevator. That is, when the first elevating member and the second elevating member are simultaneously moved, many workers can be moved to respective floors at once.

Accordingly, since the elevator can move many construction materials at once and perform construction quickly, a construction period is reduced so that a construction cost can be reduced.

In addition, in a case in which there are not many workers or construction materials to be transferred, since the second elevating member is quickly separated from the first elevating member so that only one first elevating member is operated, power consumed by the elevators can be reduced. In this case, the worker can quickly and conveniently separate the first elevating member from the second elevating member using a connecting member.

### DESCRIPTION OF DRAWINGS

FIG. 1 is a front view illustrating an elevator according to one embodiment of the present invention.

FIG. 2 is a side view illustrating the elevator according to one embodiment of the present invention.

FIG. 3 is a view illustrating a connecting unit of the elevator according to the present invention.

### MODES OF THE INVENTION

Hereinafter, embodiments of the present invention will be described in detail with reference to the accompanying drawings in order for those skilled in the art to easily perform the present invention. The present invention may be implemented in several different forms and is not limited to the embodiments described herein.

Parts irrelevant to the description will be omitted in order to clearly describe the present invention, and the same or similar parts are denoted by the same reference numerals throughout this specification.

In addition, in the various embodiments, parts having the same components are described in only a representative embodiment using the same reference numerals, and other components which are different from those in the representative embodiment will be described in the other embodiments.

Throughout this specification, when the part is referred to as being “connected” to another part, it includes “directly connected” and “indirectly connected” via an intervening part. Also, when a certain part “includes” a certain component, other components are not excluded from being included unless explicitly described otherwise, and other components may in fact be included.

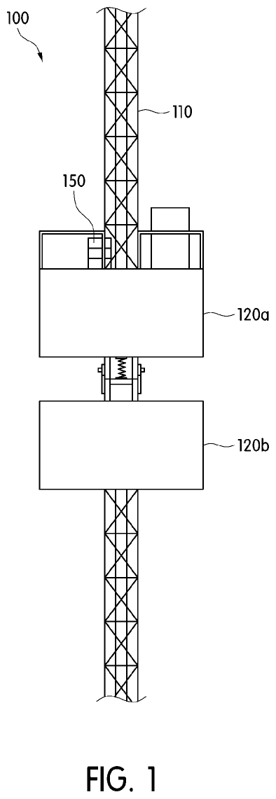

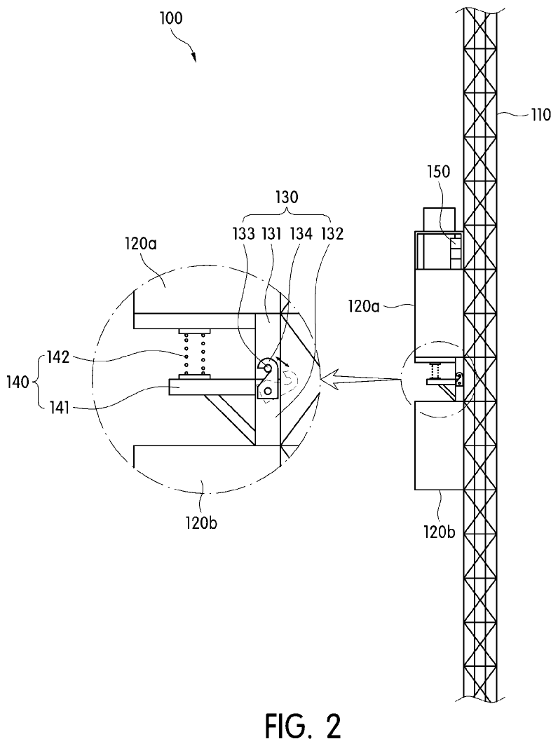

FIG. 1 is a front view illustrating an elevator according to one embodiment of the present invention, and FIG. 2 is a side view illustrating the elevator according to one embodiment of the present invention.

Referring to FIGS. 1 and 2, an elevator 100 according to one embodiment of the present invention includes a guide member 110, a first elevating member 120a, a second elevating member 120b, and a connecting unit 130.

The guide member 110 is spaced apart from a structure and formed in a vertical direction with respect to the ground. As an example, the guide member 110 may be a structure having a frame shape.

The first elevating member 120a is coupled to the guide member 110 to be moveable in a longitudinal direction of the guide member 110.

The second elevating member 120b is coupled to the guide member 110 in the longitudinal direction of the guide member 110. In addition, the second elevating member 120b is disposed under and detachably coupled to a lower side of the first elevating member 120a and is lifted and lowered together with the first elevating member 120a.

An operation button (not shown) may be installed on the first elevating member 120a or the second elevating member 120b. When a worker manipulates the operation button, the operation button generates an actuation signal to lift or lower the first elevating member 120a and the second elevating member 120b.

The operation button may be installed on any one of the first elevating member 120a and the second elevating member 120b or may also be installed on both of the first elevating member 120a and the second elevating member 120b. However, the operation button may be installed on only the first elevating member 120a to prevent errors due to multiple inputs of workers.

In addition, doors (not shown) may be installed on the first elevating member 120a and the second elevating member 120b. The door may allow the worker to enter and exit and may also close an access space.

Since a control box and various components for operations which may be installed in the first elevating member 120a and the second elevating member 120b are well known, detailed descriptions thereof will be omitted.

The connecting unit 130 connects the first elevating member 120a and the second elevating member 120b. Since the first elevating member 120a and the second elevating member 120b are stably connected by the connecting unit 130, the first elevating member 120a and the second elevating member 120b may be simultaneously lifted or lowered. To this end, descriptions about the connecting unit 130 will be described below.

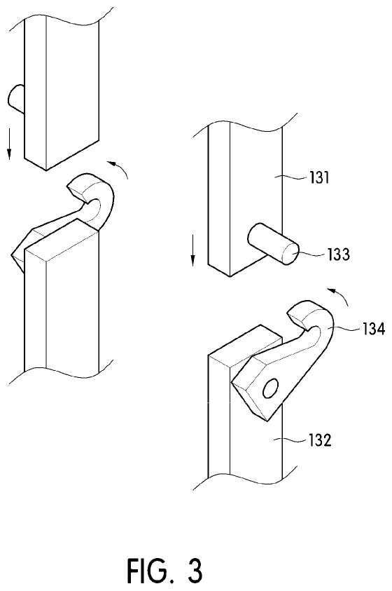

FIG. 3 is a view illustrating the connecting unit in the elevator according to the present invention of FIG. 1.

Referring to FIG. 3, as an example, the connecting unit 130 may include a first extension member 131, a second extension member 132, a fixing member 133, and a hook member 134.

The first extension member 131 is formed to extend from the lower side of the first elevating member 120a toward the second elevating member 120b.

The second extension member 132 is formed to extend from an upper side of the second elevating member 120b toward the second elevating member 120b and corresponds to the first extension member 131. For example, the number of first extension members 131 may be the same as the number of the second extension members 132.

In addition, in a case in which the first elevating member 120a is coupled to the second elevating member 120b, a free end of the second extension member 132 and a free end of the first extension member 131 may be formed to be pressed against each other.

The fixing member 133 may be formed to protrude in a direction away from one side surface of any one of the first extension member 131 or the second extension member 132. As an example, a shape of the fixing member 133 may be a cylindrical shape but is not limited thereto and may be any shape as long as the hook member 134 is hooked to the fixing member 133.

As an example, the above-described shapes of the first extension member 131 and the second extension member 132 may be provided as stick shapes having predetermined thicknesses. In this case, when the fixing member 133 is formed on the first extension member 131, the fixing member 133 may be a member having a cylindrical shape disposed perpendicularly to the first extension member 131.

In this case, for the sake of convenience in the description, it is assumed that the fixing member 133 is formed on the first extension member 131.

The hook member 134 is rotatably coupled to one side surface of any one of the first extension member 131 or the second extension member 132 and is coupled to the fixing member 133.

For example, in a case in which the hook member 134 is rotatably coupled to the second extension member 132, the hook member 134 may be hinge-coupled to one side surface of the second extension member 132 to be rotated in the vertical direction. That is, while the hook member 134 is rotated in the vertical direction, the hook member 134 may be coupled to or uncoupled from the fixing member 133.

When the first extension member 131 formed on the first elevating member 120a and the second extension member 132 formed on the second elevating member 120b are pressed against each other, the worker may couple the hook member 134 to the fixing member 133 to connect the first elevating member 120a and the second elevating member 120b.

Meanwhile, referring back to FIG. 2, the elevator 100 according to one embodiment of the present invention may include a spacing unit 140.

The spacing unit 140 is formed between the first elevating member 120a and the second elevating member 120b so that the first elevating member 120a is spaced apart from the second elevating member 120b by a predetermined distance.

To this end, as an example, the spacing unit 140 may include a support member 141 and an elastic member 142.

The support member 141 has a height and is formed on any one of the lower side of the first elevating member 120a and the upper side of the second elevating member 120b. As an example, the support member 141 may be a structure having a frame shape but is not limited thereto.

However, it may be advantageous that a portion of the support member 141 in contact with the elastic member 142, which will be described below, is formed to have a flat plate shape to increase a force pressing against the elastic member 142.

The elastic member 142 is formed to be elastically deformed. The elastic member 142 is formed on the remaining one of the lower side of the first elevating member 120a and the upper side of the second elevating member 120b and elastically supports the support member 141.

To this end, as an example, the elastic member 142 may be a compression spring. In a case in which the elastic member 142 is formed on the first elevating member 120a, an upper end of the elastic member 142 may be fixedly coupled to the lower side of the first elevating member 120a.

Since the spacing unit 140 causes the first elevating member 120a and the second elevating member 120b to be spaced apart from each other by the predetermined distance, the first elevating member 120a and the second elevating member 120b may be positioned at two adjacent floors of a structure. In addition, the spacing unit 140 may reduce an impact generated when the first elevating member 120a and the second elevating member 120b are connected.

In the elevator 100 according to one embodiment of the present invention, when the first elevating member 120a and the second elevating member 120b are connected, the first elevating member 120a and the second elevating member 120b are pressed against each other and positioned in a state in which the first elevating member 120a and the second elevating member 120b are spaced apart from each other by the spacing unit 140. Then, the worker connects the hook member 134 and the fixing member 133 so that the first elevating member 120a and the second elevating member 120b can be simply and rapidly connected.

Meanwhile, the elevator 100 according to one embodiment of the present invention may include a driving unit 150.

The driving unit 150 is installed on the first elevating member 120a and generates power such that the first elevating member 120a and the second elevating member 120b are lifted and lowered along the guide member 110.

To this end, as an example, the driving unit 150 may include a motor (not shown) and a pinion gear (not shown). The motor may be a rotating motor. The pinion gear may be coupled to a rotating shaft of the motor. The motor and the pinion gear may also be connected through a reducer.

In addition, the driving unit 150 may also include a brake (not shown) for braking the first elevating member 120a. In this case, since the brake may be a brake included in a general elevator, the detailed description thereof will be omitted.

Meanwhile, a rack gear may be formed on one side surface of the guide member 110. The pinion gear is rotated by the motor and is engaged with the rack gear so that the first elevating member 120a may be lifted or lowered. However, the driving unit 150 is not necessarily limited to including the motor and the pinion gear and the rack gear is not limited to being formed on the guide member 110, and any driving unit 150 capable of lifting or lowering the first elevating member 120a may be allowed.

The driving unit 150 may be provided as one driving unit or a plurality of driving units. For example, one driving unit 150 may be installed on the first elevating member 120a. Alternatively, two driving units 150 may be positioned to be parallel in a vertical direction on the first elevating member 120a. However, the number of the driving units 150 is not specifically limited, and it may be preferable that the number of the driving units 150 is sufficient to lift and lower both of the first elevating member 120a and the second elevating member 120b.

Hereinafter, an operation process of the elevator 100 according to one embodiment of the present invention provided with the above-described structure will be described. In this case, the operation process will be described with an assumption that the operation button is installed on only the first elevating member 120a.

When the worker who rides the first elevating member 120a inputs a 7th floor operation button, the first elevating member 120a may move to the 7^{th} floor, and the second elevating member 120b may move to a 6^{th} floor. Workers who are riding the first elevating member 120a and the second elevating member 120b may transfer construction materials to respective floors.

Since the first elevating member 120a and the second elevating member 120b of the elevator 100 according to one embodiment of the present invention are simultaneously moved as described above, an amount of materials transferred at once may be increased approximately twice when compared to a conventional elevator. Particularly, in a case in which there are many construction materials to be transferred, the first elevating member 120a and the second elevating member 120b are simultaneously moved so that many workers can be moved to respective floors at once.

Accordingly, since the elevator 100 according to the present invention may move many construction materials at once, construction can be performed faster, and thus a construction period can be reduced so that a construction cost can be reduced.

In addition, in a case in which there are not many workers or construction materials to be transferred, the second elevating member 120b may be rapidly separated from the first elevating member 120a and only one first elevating member 120a may be operated so that power consumed by the elevator 100 can be reduced. In this case, the worker may quickly and conveniently separate the first elevating member 120a from the second elevating member 120b using a connecting member.

While various embodiments of the present invention have been described above, the drawings which have been referenced and detailed descriptions of the present invention are only for illustrating the present invention and are used only for describing the present invention and not for limiting terms or the scope of the present invention defined by the claims. Therefore, it will be understood by those skilled in the art that various modifications and equivalent other examples may be made. Therefore, the scope of the present invention is defined by the appended claims.

1. An elevator comprising:
a guide member spaced apart from a structure and formed in a vertical direction with respect to the ground;
a first elevating member coupled to the guide member to be moveable in a longitudinal direction of the guide member;
a second elevating member coupled to the guide member to be moveable in the longitudinal direction of the guide member, detachably coupled to a lower side of the first elevating member, and lifted and lowered together with the first elevating member; and
at least one connecting unit which connects the first elevating member and the second elevating member.

2. The elevator of claim 1, wherein the connecting unit includes:
a first extension member formed to extend from the lower side of the first elevating member toward the second elevating member;
a second extension member formed to extend from an upper side of the second elevating member toward the first elevating member and corresponding to the first extension member;
a fixing member formed to protrude in a direction away from a side surface of any one of the first extension member or the second extension member; and
a hook member rotatably coupled to a side surface of any one of the first extension member or the second extension member and coupled to the fixing member.

3. The elevator of claim 1, further comprising a spacing unit formed between the first elevating member and the second elevating member so that the first elevating member and the second elevating member are spaced apart from each other by a predetermined distance.

4. The elevator of claim 3, wherein the spacing unit includes:
a support member having a height and formed on any one of the lower side of the first elevating member and an upper side of the second elevating member; and
an elastic member which is formed on the remaining one of the lower side of the first elevating member and the upper side of the second elevating member to be elastically deformed and elastically supports the support member.

5. The elevator of claim 1, further comprising at least one driving unit which is installed on the first elevating member and generates power to lift and lower the first elevating member and the second elevating member along the guide member.
